(19) United States
(12) Patent Application Publication
(10) Pub. No.: US 2003/0101831 A1
(43) Pub. Date: Jun. 5, 2003

(54) Pipette with simplified disassembly

(76) Inventor: Francois Viot, Auvers-sur-Oise (FR)

Correspondence Address: PHILIP M. KOLEHMAINEN, GREER, BURNS & CRAIN, LTD., SUITE 2500, 300 SOUTH WACKER DRIVE, CHICAGO, IL, 60606, US

(21) Appl. No.: 10/239,725

(22) PCT Filed: Apr. 9, 2001
(86) PCT No.: PCT/FR01/01067

(30) Foreign Application Priority Data
Apr. 7, 2000 (FR) 00/04477

(51) Int. Cl. B01L 3/02

(52) U.S. Cl. 73/864.01

(57) ABSTRACT

The sampling pipette comprises an endpiece (4); a. piston (8) slidably movable in the endpiece; and a gasket (36) in contact with the endpiece and with the piston to provide sealing between them. The endpiece comprises two portions (4a, 4b) fixed to each other in releasable manner with the gasket (36) being interposed between them.

The invention relates to pipettes for taking samples of liquids.

By way of example, documents FR-2 696 110 and FR2 203 680 disclose pipettes for taking samples of liquid. Those pipettes have an external endpiece at a bottom end in which there slides an internal piston. The movement of the piston causes the liquid to be sucked into or to be expelled from the endpiece. To make this possible, a gasket is interposed between the endpiece and the piston in order to provide sealing between them.

It is desirable for that type of pipette to be further improved. Changing the gasket generally requires not only the endpiece to be removed, but also several other parts. Unfortunately, during such handling, parts can be damaged or dirtied. Furthermore, putting the parts back together in the correct arrangement requires care and attention, particularly when performed by the user of the pipette. Finally, such disassembly with reassembly after disassembly often leads to the calibration of the pipette being modified, making it necessary to recalibrate the pipette.

An object of the invention is to provide a pipette that limits the amount of handling that needs to be performed in order to change the gasket, and that limits any risk of loss of calibration.

To achieve this object, the invention provides a sampling pipette comprising: an endpiece; a piston slidably movable in the endpiece; and a gasket in contact with the endpiece and with the piston to provide sealing between them; in which the endpiece comprises two portions fixed to each other in releasable manner with the gasket being interposed between them.

It thus suffices to remove the endpiece or one of its portions in order to gain access to the gasket. This access does not require numerous other parts to be removed from the pipette. The way in which those parts are arranged is thus left undisturbed, thereby limiting any risk of loss of calibration. The risk of the parts being damaged or dirtied is also avoided. Access to the gasket is thus made simpler overall.

Advantageously, the pipette is arranged in such a manner that one of the endpiece portions can be separated from the other endpiece portion without separating said other portion from the remainder of the pipette.

It thus suffices to remove one of the portions of the endpiece in order to access the gasket directly. The other parts can therefore remain protected or held by the other portion of the endpiece. This further limits the risk of the pipette losing calibration or of the parts damaged or dirtied. In addition, it is possible to envisage having a range of models for the removable portion of the endpiece in order to modify the configuration of the pipette, for example in order to adapt it at will to various types of sampling cone.

Advantageously, the gasket is compressed between the two endpiece portions.

Thus, the number of parts needed for obtaining good sealing is limited. The structure of the pipette associated with the gasket is thus particularly simple.

Advantageously, the two portions form a housing receiving the gasket, the housing having a face presenting a setback in which there extends a fraction of the gasket.

This makes it possible to slacken manufacturing tolerances for the gasket and for the two portions of the endpiece without harming sealing or freedom of movement for the piston. In addition, this setback serves to center the gasket radially relative to the axis of the pipette, thus improving gasket positioning. In addition, it has edges which, on coming into contact with the gasket, form a corresponding number of additional sealing points. It also provides a reserve of elasticity for compressing the gasket so that the force with which the gasket is clamped against the piston varies little as a function of the relative position of the two portions of the endpiece, i.e. as a function of their relative clamping or as a function of the aging of the gasket. Quality of fixing is therefore not critical with respect to sealing.

The invention may also present at least one of the following characteristics:

the setback is formed in a face of the housing that is essentially perpendicular to a longitudinal axis of the pipette;

the setback is formed in a bottom face of the housing;

the two portions are fixed to each other by means of a male-female assembly;

the setback is formed in the male portion;

the two portions are screwed one in the other; and

one of the two portions forms a bottom end of the pipette, e.g. suitable for receiving a disposable sampling cone.

Other characteristics and advantages of the invention appear further from the following description of a preferred embodiment given by way of non-limiting example. In the accompanying drawings:

FIG. 1 is a fragmentary axial section view of a pipette constituting a preferred embodiment of the invention;

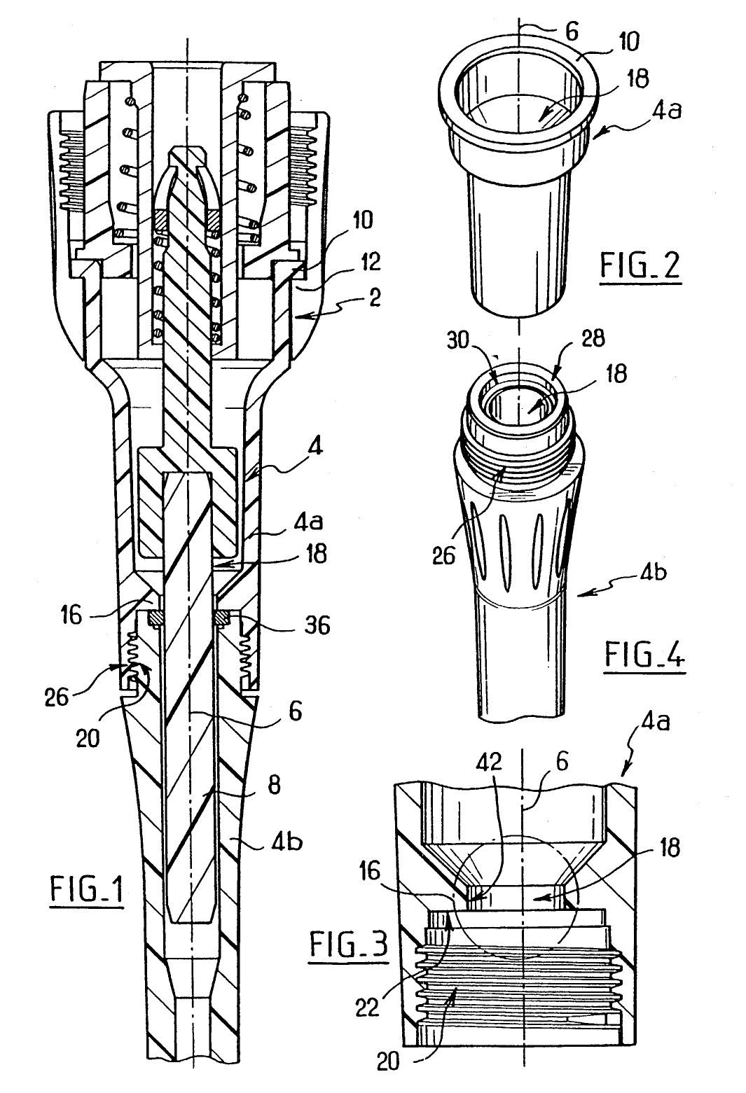

FIG. 2 is a perspective view of the top portion of the FIG. 1 endpiece;

FIG. 3 is a fragmentary axial section view of the top portion of the endpiece shown in FIG. 2;

FIG. 4 is a fragmentary perspective view of the bottom portion of the endpiece shown in FIG. 1;

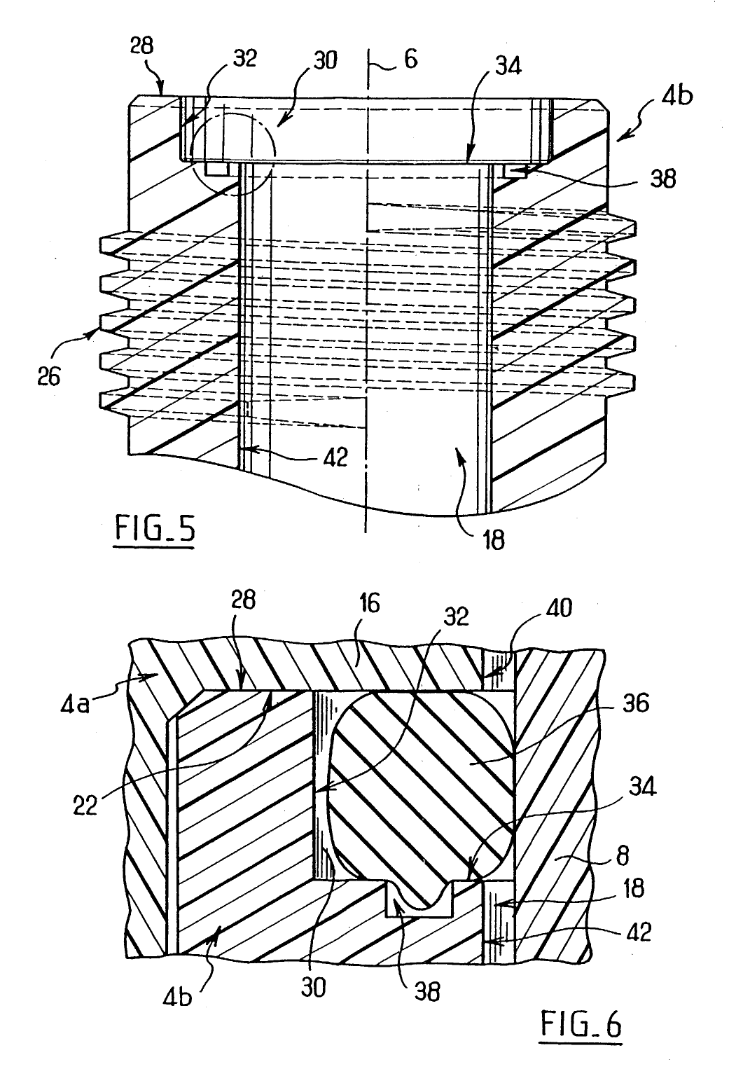

FIG. 5 is a fragmentary axial section view of the bottom portion of the endpiece shown in FIG. 4; and

FIG. 6 is a view of the FIG. 1 pipette on a larger scale, showing the compressed gasket.

With reference to FIG. 1, the sampling pipette of the present embodiment of the invention comprises a pipette body 2 and an endpiece 4 fixed to the body 2. The pipette extends in a longitudinal direction along an axis 6. The body has the conventional parts of a sampling pipette, specifically a handle for holding in the hand, an actuator button at the top end of the body, a counter, means for adjusting the volume to be taken, etc. These parts are conventional and they are not shown. By means of a conventional mechanism integrated in the body, a downward action on the button causes a piston 8 of cylindrical shape to slide downwards in the endpiece 4 along the axis 6. The piston rises under drive from a return spring. The pipette can be arranged so that the liquid injection stroke of the piston is followed by a purge stroke.

The endpiece 4 has a top portion 4a and a bottom portion 4b in the form of two separate parts. The top and bottom portions 4a and 4b lie on the same axis and they define successive zones of a single internal duct 18 in which the piston 6 moves.

The bottom portion 4b constitutes the bottom end of the pipette. It is designed to receive a disposable sampling cone which is secured by friction to the bottom end of the pipette. The pipette includes an ejector for subsequently separating the cone from the pipette.

The top portion 4a is interposed longitudinally between the body 2 and the bottom portion 4b. The top portion 4a is fixed via its top end to the body 2 by means of a flange 10 which projects outwards from its rim. This flange bears axially against a shoulder 12 of the body that is of complementary shape. The top portion need not be separable from the body independently of the parts internal to the body. During assembly of the pipette, it has its bottom end threaded through the top end of the body and then pushed downwards so as to come out through its bottom end. The other parts are then installed inside the body, thereby locking the portion 4a in place. The top portion 4a flares upwardly. Close to its bottom end it has an internal shoulder 16. The shoulder 16 projects radially into the duct 18. Beneath the shoulder 16, the top portion 4a has a female threaded zone 20. Beside this zone the shoulder presents a plane face 22 perpendicular to the axis 6.

The bottom portion 4b of the endpiece has a top end segment of smaller diameter than the remainder of said portion. This segment has a male thread 26 suitable for screw engagement with the female thread 20 of the top portion 4a. The top end of the bottom portion 4b is formed by a plane face 20 perpendicular to the axis 6 for coming into abutment against the face 22 of the other portion 4a when these two parts are screwed together, thus-defining accurately their relative position when fixed together. This face 28 is set back in its portion contiguous with the duct 18 to form a shoulder 30 presenting a cylindrical face 32 about the axis 6 facing the duct 18 and a plane bottom face 34 perpendicular to the axis 6.

The three faces 22, 32, and 34 form a generally annular housing opening out radially towards the duct 18 and receiving a sealing gasket in the form of an O-ring 36. In addition, an annular groove 38 of upwardly facing U-shaped profile is formed in the bottom face 34 at a distance from its two circumferential edges. The width of this groove is much less than the width of the face 34 and in this case it is about half as wide.

The piston 8 is slidably movable in the duct 18, remaining at a distance from the faces 40 and 42 of the top and bottom portions 4a and 4b. In contrast, the gasket 36 bears against the cylindrical side face of the piston. It also bears against the faces 22 and 34 (but not the face 32) so that the cross-section of the gasket which is circular when the gasket is not under stress, becomes deformed. A fraction of the gasket penetrates into the groove 38. Because the faces 22 and 28 press against each other, the gasket need not be excessively compressed between the two endpiece portions 4a and 4b. The gasket provides sealing between the piston and the endpiece relative to the bottom end of the pipette that receives the liquid that is to be taken.

To access the gasket 36, it suffices to unscrew the bottom portion 4b. Once removed, the gasket can be seen in the housing 30 thereof. The gasket can then be removed and changed. It can thus be seen that the bottom portion 4b can be removed without disassembling any other parts of the pipette, and in particular without removing the top portion 4a. The only internal part of the pipette which is exposed during this operation is the piston.

The gasket 36 provides satisfactory sealing between the endpiece 4 and the piston 8. The cavity 38 forms a reserve of volume for the gasket. When the gasket is new, a large fraction of the gasket is received therein. This fraction becomes smaller as the gasket ages. The pressure applied by the gasket on the piston thus remains essentially constant throughout the lifetime of the gasket and regardless of gasket tolerances. The quality of sealing thus remains substantially constant.

1./ A sampling pipette comprising:
an endpiece (4);
a piston (8) slidably movable in the endpiece; and
a gasket (36) in contact with the endpiece and with the piston to provide sealing between them;
the pipette being characterized in that the endpiece comprises two portions (4a, 4b) fixed to each other in releasable manner with the gasket (36) being interposed between them.

2/ A pipette according to claim 1, characterized in that it is arranged in such a manner that one of the endpiece portions (4b) can be separated from the other endpiece portion (4a) without separating said other portion from the remainder of the pipette.

3/ A pipette according to claim 1 or claim 2, characterized in that the gasket (36) is compressed between the two endpiece portions (4a, 4b).

4/ A pipette according to any one of claims 1 to 3, characterized in that the two portions (4a, 4b) form a housing (30) receiving the gasket (36), the housing having a face (34) presenting a setback (38) in which there extends a fraction of the gasket.

5/ A pipette according to claim 4, characterized in that the setback (38) is formed in a face (34) of the housing that is essentially perpendicular to a longitudinal axis (6) of the pipette.

6/ A pipette according to claim 4 or claim 5, characterized in that the setback (38) is formed in a bottom face (34) of the housing (30).

7/ A pipette according to any one of claims 1 to 6, characterized in that the two portions (4a, 4b) are fixed to each other by means of a male-female assembly.

8/ A pipette according to any one of claims 4 to 6, and according to claim 7, characterized in that the setback (38) is formed in the male portion (4b).

9/ A pipette according to any one of claims 1 to 8, characterized in that the two portions (4a, 4b) are screwed one in the other.

10/ A pipette according to any one of claims 1 to 9, characterized in that one of the two portions (4b) forms a bottom end of the pipette, e.g. suitable for receiving a disposable sampling cone.
